(19) United States
(12) Patent Application Publication
(10) Pub. No.: US 2009/0315445 A1
(43) Pub. Date: Dec. 24, 2009

(54) FLAT PANEL DISPLAY DEVICE HAVING ELECTRODE PROTECTING LAYER

(75) Inventor: Eung-Joon Chi, Suwon-si (KR)

Correspondence Address: CHRISTIE, PARKER & HALE, LLP, PO BOX 7068, PASADENA, CA, 91109-7068, US

(73) Assignee: Samsung SDI Co., Ltd

(21) Appl. No.: 12/551,469

(22) Filed: Aug. 31, 2009

Related U.S. Application Data
(62) Division of application No. 11/499,430, filed on Aug. 4, 2006.
Application No. 11/499,430 is a continuation-in-part of application No. 11/046,503, filed on Jan. 28, 2005.

(30) Foreign Application Priority Data
Jan. 30, 2004 (KR) 10-2004-0005969

(51) Int. Cl. H01J 1/00

(52) U.S. Cl. 313/311; 313/326

(57) ABSTRACT

A flat panel display device includes a first substrate and a second substrate disposed to oppose each other with a predetermined gap therebetween. An electrode made of a conductive film is formed on at least one of the first substrate and the second substrate. A sealing member is disposed between the first substrate and the second substrate and bonds the first substrate and the second substrate to each other. An electrode protecting layer is formed on a portion of the electrode overlapping with the sealing member and between the sealing member and the electrode. The electrode and the electrode protecting layer may be made of a conductive metal.

### CROSS REFERENCE TO RELATED APPLICATIONS

This application is a divisional of U.S. patent application Ser. No. 11/499,430, filed on Aug. 4, 2006, which is a continuation-in-part application of U.S. patent application Ser. No. 11/046,503, filed on Jan. 28, 2005, which in turn claims priority to and the benefit of Korean Patent Application No. 10-2004-0005969, filed on Jan. 30, 2004 in the Korean Intellectual Property Office, the entire contents of all applications of which are incorporated herein by reference.

### BACKGROUND OF THE INVENTION

1. Field of the Invention

The present invention relates to a flat panel display device, and more particularly, to a flat panel display device in which an increase in electrode resistance may be prevented.

2. Description of the Related Art

In flat panel display devices, such as the field emission display (FED), the vacuum fluorescent display (VFD), the liquid crystal display (LCD), and the plasma display panel (PDP), an upper substrate and a lower substrate are disposed with a predetermined gap, and a vacuum vessel is formed by sealing the circumferential edges of the upper substrate and the lower substrate with a sealing member.

The upper substrate or the lower substrate is provided with anode electrodes, grid electrodes, cathode electrodes, gate electrodes, etc. In addition, electrode pads for connecting the electrodes to an external power source are formed on the upper substrate or the lower substrate such that the electrode pads extend from the respective electrodes and are drawn out to the outside of the sealing member.

The anode electrodes and the gate electrodes or the cathode electrodes are made of a metal film or a transparent indium tin oxide (ITO) film, and the electrode pads are also made of the metal film or the transparent ITO film.

In the conventional flat panel display device, the sealing process using frit as the sealing member is performed in a state where the electrodes and the electrode pads are formed on the upper substrate and/or the lower substrate. The processing temperature is kept at 300° C. or higher.

When the substrates are sealed with the frit at a temperature of 300° C. or higher, the portions of the respective metal films or ITO films contacting the frit are decomposed into their ingredients in the course of baking and curing the frit, thereby causing variation of the initial composition.

Since the variation in composition of the metal film or the ITO film increases the inherent resistance thereof and the increase in resistance causes the voltage drop of the corresponding electrode, the abilities of the electrodes are deteriorated.

As a result, the flat panel display device is subjected to deterioration in image quality such as decrease in brightness and decrease in uniformity of brightness due to deterioration in ability of the electrodes, thereby lowering the performance of the display device. There is a need, therefore, for a flat panel display device wherein a decrease in brightness and a decrease in the uniformity of bright due to deterioration of electrodes can be prevented.

### SUMMARY OF THE INVENTION

An exemplary embodiment of the present invention provides a flat panel display device in which increase in electrode resistance may be prevented by forming an electrode protecting layer on a portion of an electrode passing through a sealing member which also eliminates unnecessary voltage drops and prevents a decrease in brightness and decrease in uniformity of image quality.

According to an embodiment of the present invention, a flat panel display device is provided having a first substrate and a second substrate disposed to oppose each other with a predetermined gap therebetween. An electrode is made of a conductive film formed on at least one of the first substrate and the second substrate. A sealing member is disposed between the first substrate and the second substrate and which bonds the first substrate and the second substrate to each other. An electrode protecting layer is formed on a portion of the electrode overlapping with the sealing member and between the sealing member and the electrode.

The electrode protecting layer may be made of conductive material such as metal. Specifically, the electrode protecting layer may be made of at least one material selected from a group consisting of aluminum, chromium, molybdenum, silver, gold, platinum, palladium, copper, nickel, tungsten, molybdenum-tungsten, molybdenum-manganese, lead, tin and alloys thereof.

The electrode protecting layer may be formed using a vacuum deposition method or a screen printing method.

The width of the electrode protecting layer may be greater than that of the electrode.

The width of the electrode protecting layer may be less than or substantially equal to that of the electrode. The electrode protecting layer may be formed in a single layer, or a plurality of the electrode protecting layers may be formed at intervals on the electrode.

The electrode may be formed of metal film. Specifically, the electrode may be made of at least one material selected from a group consisting of aluminum, chromium, molybdenum, silver, gold, platinum, palladium, copper, nickel, tungsten, molybdenum-tungsten, molybdenum-manganese, lead, tin and alloys thereof.

The electrode may be formed of a transparent conductive oxide film such as indium tin oxide.

The sealing member may be made of glass frit. Alternatively, the sealing member may include a support frame with a predetermined height, a first frit layer disposed between the first substrate and the support frame, and a second frit layer disposed between the second substrate and the support frame.

### BRIEF DESCRIPTION OF THE DRAWINGS

FIG. 1 is a partial perspective view illustrating a flat panel display device according to a first embodiment of the present invention.

FIG. 2 is a partial cross-sectional view illustrating the flat panel display device according to the first embodiment of the present invention.

FIG. 3 is a partial vertical cross-sectional view illustrating a state where an electrode protecting layer is formed in the flat panel display device according to the first embodiment of the present invention.

FIG. 4 is a partial horizontal cross-sectional view illustrating a state where an electrode protecting layer is formed in the flat panel display device according to the first embodiment of the present invention.

FIG. 5 is a partial vertical cross-sectional view illustrating a relation between the electrode protecting layer and an electrode pad in the flat panel display device according to the first embodiment of the present invention.

FIG. 6 is a partial perspective view illustrating a flat panel display device according to a second embodiment of the present invention.

FIG. 7 is a partial cross-sectional view illustrating the flat panel display device according to the second embodiment of the present invention.

FIGS. 8A, 8B and 8C are partial vertical cross-sectional views illustrating a relation between the electrode protecting layer and the electrode pad in the flat panel display device according to another embodiment of the present invention.

FIG. 9 is a partial vertical cross-sectional view illustrating a sealing member in the flat panel display device according to another embodiment of the present invention.

### DETAILED DESCRIPTION

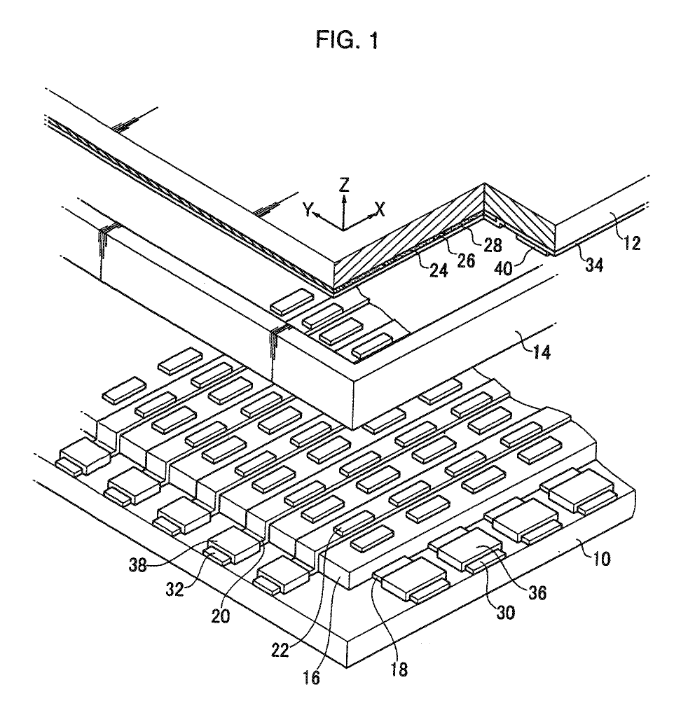

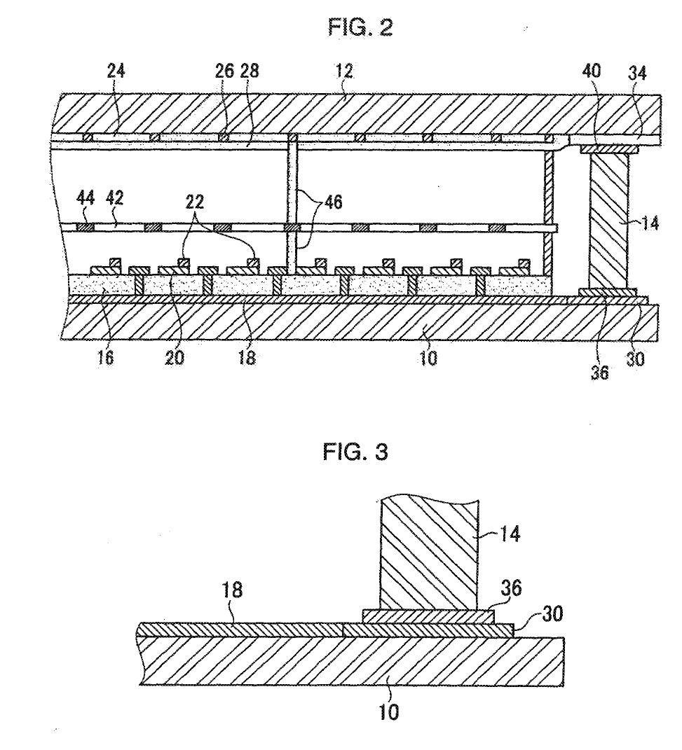

According to one embodiment of the present invention, an FEA type field emission device is shown in FIGS. 1 and 2. The field emission device includes a first substrate 10 and a second substrate 12 disposed to oppose each other with a predetermined gap therebetween. A sealing member 14 is disposed between the circumferential edges of the first substrate 10 and the second substrate 12 which seals the substrates. Gate electrodes 18 and cathode electrodes 20 are formed in a pattern intersecting each other on the first substrate 10 with an insulating layer 16 therebetween. Electron emission regions 22 are formed on the portions of the cathode electrodes 20 intersecting the gate electrodes 18.

The field emission device also includes fluorescent film 24 formed on the second substrate 12, black film 26 disposed between the fluorescent film 24, and an anode electrode 28 formed on the second substrate 12 to cover the fluorescent film 24 and the black film 26. In the present embodiment, the anode electrode 28 is made of metal film such as aluminum (Al) film.

The gate electrodes 18, the cathode electrodes 20, and the anode electrodes 28 have pads 30, 32, 34, respectively, formed out of a part of the electrodes for electrical connection to an external driving-voltage applying unit. In the present embodiment, since the electrodes 18, 20, 28 are made of conductive metal, the pads 30, 32, 34 are also made of conductive metal.

In a state where the first substrate 10 and the second substrate 12 are sealed with the sealing member 14, the pads 30, 32, 34 are disposed at the inside (inner area of a vacuum vessel formed by the substrates) and the outside (outer area of the vacuum, which is an area on the first substrate or the second substrate) of the sealing member 14 while having areas overlapping with the sealing member.

On the portions of the pads 30, 32, 34 overlapping with the sealing member 14, electrode protecting layers 36, 38, 40 contacting the pads 30, 32, 34, and the sealing member 14 are formed, respectively.

As shown in FIG. 2, between the first substrate 10 and the second substrate 12, a metal mesh-type grid electrode 44 may be further provided in which a plurality of beam-passing holes 42 are arranged in a predetermined pattern. Spacers 46 for keeping constant the gap between the substrates are disposed between both surfaces of the grid electrode 44 and the first and second substrates 10 and 12. For convenience, the grid electrode 44 and the spacers 46 are not shown in FIG. 1.

The gate electrodes 18 and the cathode electrodes 20 may be formed in a stripe pattern and are arranged substantially perpendicular to each other. For example, the gate electrodes 18 are formed in a stripe pattern along the Y axis direction of FIG. 1, and the cathode electrodes 20 are formed in a stripe pattern along the X axis direction of FIG. 1.

Between the gate electrodes 18 and the cathode electrodes 20, the insulating layer 16 is formed over the whole area of the first substrate 10.

At respective areas in which the gate electrodes 18 and the cathode electrodes 20 intersect each other, electron emission regions 22 are formed in the edges of the cathode electrodes 20.

The electron emission regions 22 serve as surface electron sources formed with a uniform thickness, and may be made of a carbon material that emits electrons well under a low-voltage driving condition of about 10 to 100V.

As the carbon material forming the electron emission regions 22, one material selected from graphite, diamond, diamond like carbon (DLC), carbon nano-tube (CNT), C60 (fullerene), etc. or a combination of two or more materials selected therefrom, may be used. Specifically, since the radius of curvature of an end of the carbon nano-tube may be as small as only a few nanometers and the carbon nano-tube emits electrons well in a low electric field of about 1 to 10 V/μm, the carbon nano-tube is an ideal electron-emission material.

On the other hand, the electron emission regions 22 made be made of a nanometer sized material such as nano-tube, nano-fiber, nano-wire, etc.

The electron emission regions 22 are not limited to the above-mentioned examples, but may be formed in various shapes such as a cone shape, a wedge shape, a thin film edge shape, etc.

In the present embodiment as described above, the gate electrodes 18 are formed on the first substrate 10 and the cathode electrodes 20 are formed on the gate electrodes 18 with the insulating layer 16 therebetween. However, the cathode electrodes may be first formed on the first substrate and then the gate electrodes may be formed on the cathode electrodes with the insulating layer therebetween. In this case, holes penetrating the gate electrodes and the insulating layer are formed at the intersections between the cathode electrodes and the gate electrodes, and the electron emission regions are formed on the surface of the cathode electrodes exposed through the holes.

The first substrate 10 and the second substrate 12 having the above-mentioned construction are sealed with a predetermined gap by the sealing member 14, and the inner space therebetween is exhausted, thereby maintaining a vacuum.

In order to keep constant the gap between the first substrate 10 and the second substrate 12, the spacers 46 are arranged at predetermined intervals between the first substrate 10 and the second substrate 12. In one exemplary embodiment, the spacers 46 are provided to avoid positions of pixels and paths of electron beams.

The electrode pads 30, 32 for applying voltages to the gate electrodes 18 and the cathode electrodes 20 formed on the first substrate 10 and the electrode pads 34 for applying a voltage to the anode electrode 28 formed on the second substrate 12 may be made of metal film.

As the conductive metal forming the electrodes 18, 20, 28 and the electrode pads 30, 32, 34, one material selected from a group consisting of aluminum (Al), chromium (Cr), molybdenum (Mo), silver (Ag), gold (Au), platinum (Pt), palladium (Pd), copper (Cu), nickel (Ni), tungsten (W), molybdenum-tungsten (Mo—W), molybdenum-manganese (Mo—Mn), lead (Pb), tin (Sn) and alloys thereof, or a combination of two or more materials selected therefrom may be used.

The electrode protecting layers 36, 38, 40 formed on the electrode pads 30, 32, 34 may be made of conductive material such as metal.

As the conductive metal forming the electrode protecting layers 36, 38, 40, one material selected from a group consisting of aluminum (Al), chromium (Cr), molybdenum (Mo), silver (Ag), gold (Au), platinum (Pt), palladium (Pd), copper (Cu), nickel (Ni), tungsten (W), molybdenum-tungsten (Mo—W), molybdenum-manganese (Mo—Mn), lead (Pb), tin (Sn), and alloys thereof, or a combination of two or more materials selected therefrom may be used.

The electrode protecting layers 36, 38, 40 may be formed using a vacuum deposition method or a screen printing method.

When the electrode protecting layers 36, 38, 40 are formed using the screen printing method, a paste of conductive metal may be used.

In one exemplary embodiment, fine particles having a diameter of several microns (μm) or less are used as the conductive metal made into paste to form the electrode protecting layers 36, 38, 40 using the screen printing method.

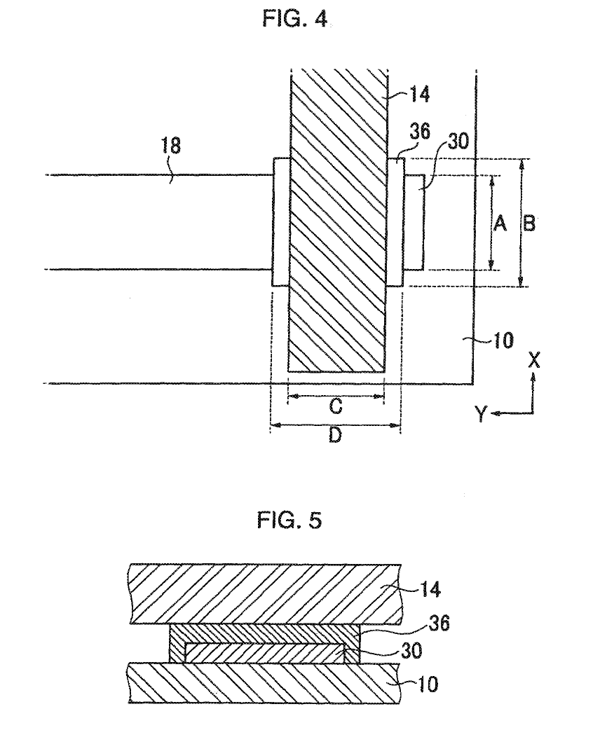

As shown in FIG. 4, in the present embodiment the electrode protecting layers 36, 38, 40 may be formed with a width D which is sufficiently greater than the width C of the sealing member 14 so as to completely prevent contact of the electrode pads 30, 32, 34 with the sealing member 14. Here, the width C and the width D are measured in the Y axis direction of FIG. 1.

As further shown in FIG. 4, the electrode protecting layers 36, 38, 40 may be formed with a width B which is sufficiently greater than the width A of the electrode pads 30, 32, 34 so as to completely prevent contact of the electrode pads 30, 32, 34 with the sealing member 14. The electrode protecting layers 36, 38, 40 may be formed to cover the top surfaces and both side surfaces of the electrode pads 30, 32, 34. Here, the width A and the width B are measured in the X axis direction of FIG. 1.

The gate electrodes 18, the electrode pads 30, and the electrode protecting layers 36 are shown in FIGS. 3, 4, and 5.

In this embodiment, the sealing member 14 is formed of glass frit. The sealing step using the glass frit is performed at a temperature of about 300° C. or higher.

In the sealing step, high-temperature heat of about 300° C. or higher is applied. However, since the electrode pads 30, 32, 34 do not come in direct contact with the sealing member 14 by the electrode protecting layers 36, 38, 40, thermal decomposition is slight and there is little to no increase in resistance.

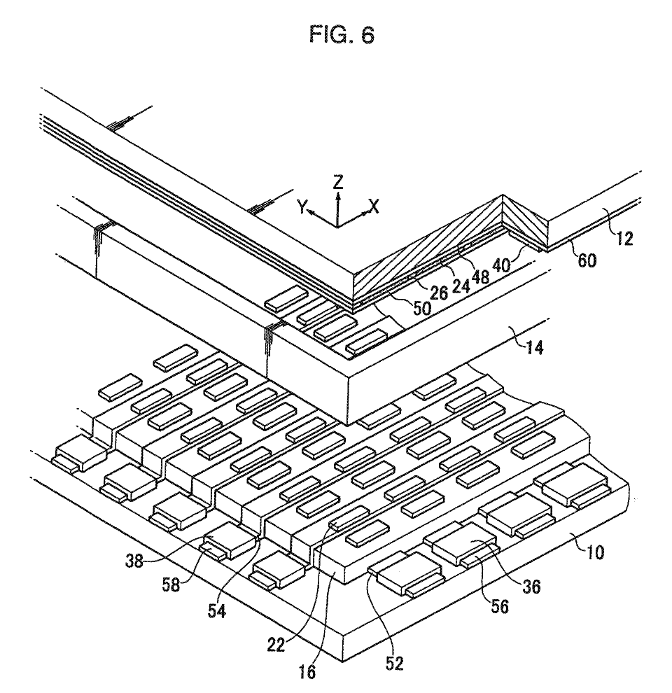

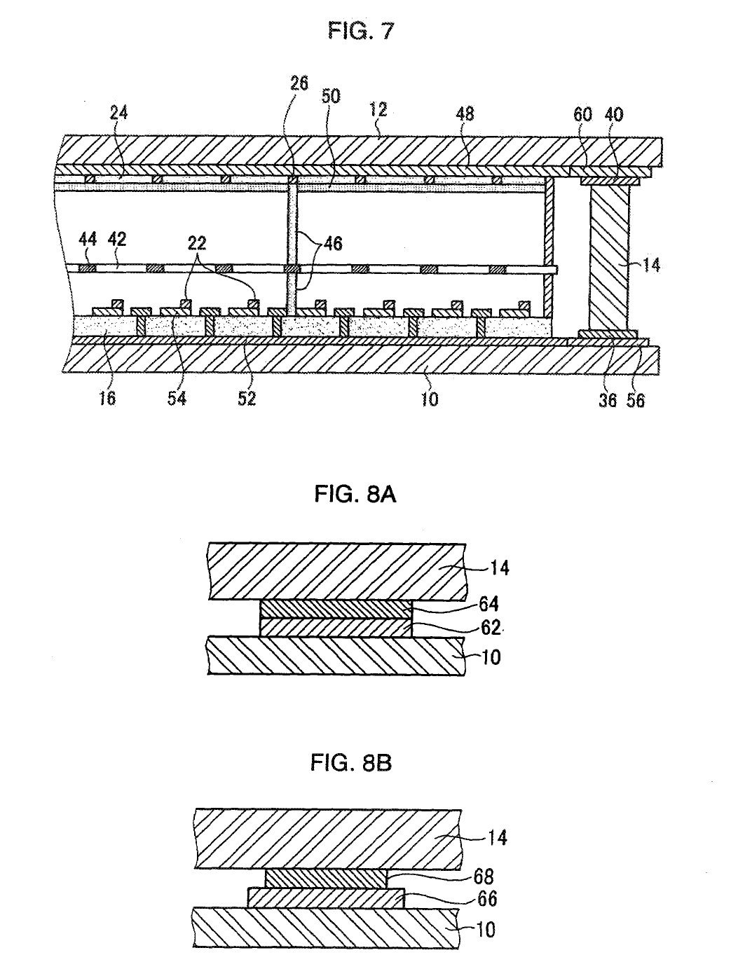

As shown in FIGS. 6 and 7, a field emission device according to a second embodiment of the present invention includes an anode electrode 48 formed on the second substrate 12, fluorescent film 24 formed in a predetermined pattern on one surface of the anode electrode 48, and black film 26 disposed between the fluorescent film 24.

The field emission device may further include metal film 50 formed on the anode electrode 48 to cover the fluorescent film 24 and the black film 26. In an exemplary embodiment the anode electrode 48 may be made of indium tin oxide (ITO) which forms a transparent conductive film, and the metal film 50 may be made of an Al thin film.

In this embodiment, the gate electrodes 52 and the cathode electrodes 54 may be formed of the transparent conductive film such as ITO. Also, the electrode pads 56, 58, 60 for applying voltages to the gate electrodes 52, the cathode electrodes 54 and the anode electrode 48, respectively, may be made of the ITO film.

On the portions of the pads 56, 58, 60 overlapping with the sealing member 14, electrode protecting layers 36, 38, 40 contacting the pads 56, 58, 60, and the sealing member 14 are formed, respectively. Therefore, since the electrode pads 56, 58, 60 do not come in direct contact with the sealing member 14 by the electrode protecting layers 36, 38, 40, in the sealing step, thermal decomposition is slight and there is little to no increase in resistance.

According to the first and the second embodiment of the flat panel display device of the present invention, even when the sealing step using the sealing member and the exhausting step are performed at a temperature of 300° C. or higher, the electrode pads are protected by the electrode protecting layers. Therefore, the resistances of the electrode pads and the electrodes having the electrode pads are not increased, thus preventing unnecessary voltage drop from occurring.

As a result, since the flat panel display device does not undergo a decrease in brightness and a decrease in driving voltage, it is possible to enhance the uniformity of image quality.

Although the FEA type field emission device has been used as an example, embodiments of the present invention are not limited to this type of device. Rather, embodiments of the present invention may be applied to different kinds of flat panel display devices such as a PDP, an organic electroluminescence device (OLED), an LCD, etc.

Although it has been described in the above-mentioned embodiments that the electrode protecting layers are all formed on the electrode pads, the present invention is not limited to the embodiments, but may be applied to a case where the electrode protecting layer is formed on at least one electrode pad.

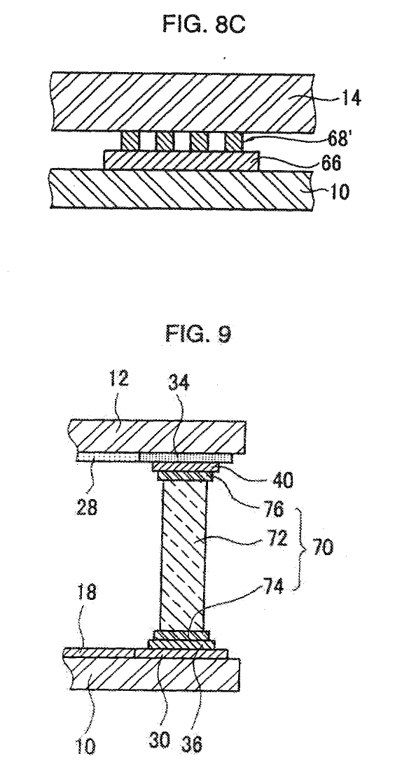

Additionally, FIGS. 8A to 8C are cross-sectional views illustrating various patterns of an electrode protecting layer according to the present invention, which are viewed from the Y axis direction of FIG. 1. In the figures, an electrode pad of a gate electrode formed on a first substrate and an electrode protecting layer formed on the electrode pad are depicted.

FIG. 8A shows a case where the width of the electrode pad 62 of the gate electrode formed on the first substrate 10 is substantially equal to the width of the electrode protecting layer 64 formed on the electrode pad 62.

FIGS. 8B and 8C show a case where the width of the electrode protecting layer 68 is less than the width of the electrode pad 66 in a state that the electrode pad 66 and the electrode protecting layer 68 of the gate electrode are sequentially formed on the first substrate 10.

In this case, the electrode protecting layer 68 may be formed in a single body (see FIG. 8B), or may be formed in plural portions 68′ with intervals (see FIG. 8C).

Although it has been described in the above-mentioned embodiments that the sealing member is made of glass frit, but as shown in FIG. 9, the sealing member 70 may include a support frame 72 with a predetermined height, a first frit layer 74 disposed between the support frame 72 and the first substrate 10, and a second frit layer 76 disposed between the support frame 72 and the second substrate 12.

The support frame 72 keeps constant the gap between the first substrate 10 and the second substrate 12 at the periphery of the vacuum vessel. The support frame 72 may be made of glass or ceramic.

Although exemplary embodiments of the present invention have been described, the present invention is not limited to the exemplary embodiments, but rather may be modified in various forms without departing from the scope of the appended claims, the detailed description, and the accompanying drawings of the present invention. Therefore, it will be understood by those skilled in the art that such modifications belong to the scope of the present invention.

What is claimed is:

1. A flat panel display device comprising:
a first substrate and a second substrate disposed opposite to each other with a predetermined gap therebetween;
an electrode made of a conductive film formed on at least one of the first substrate and the second substrate;
a sealing member disposed between the first substrate and the second substrate which bonds the first substrate and the second substrate to each other; and
an electrode protecting layer made of a conductive material and formed on a portion of the electrode overlapping with the sealing member and between the sealing member and the electrode.

2. The flat panel display device of claim 1, wherein the conductive material is metal.

3. The flat panel display device of claim 1, wherein the conductive material is selected from the group consisting of aluminum, chromium, molybdenum, silver, gold, platinum, palladium, copper, nickel, tungsten, molybdenum-tungsten, molybdenum-manganese, lead, tin and alloys thereof.

4. The flat panel display device of claim 1, wherein the electrode protecting layer is formed using a vacuum deposition method or a screen printing method.

5. The flat panel display device of claim 1, wherein the width of the electrode protecting layer is substantially equal to that of the electrode.

6. The flat panel display device of claim 1, wherein the width of the electrode protecting layer is less than that of the electrode.

7. The flat panel display device of claim 6, wherein the electrode protecting layer is formed in a single layer.

8. The flat panel display device of claim 6, wherein a plurality of the electrode protecting layers are formed at intervals on the electrode.

9. The flat panel display device of claim 1, wherein the electrode is made of metal.

10. The flat panel display device of claim 9, wherein the electrode is made of at least one material selected from the group consisting of aluminum, chromium, molybdenum, silver, gold, platinum, palladium, copper, nickel, tungsten, molybdenum-tungsten, molybdenum-manganese, lead, tin and alloys thereof.

11. The flat panel display device of claim 1, wherein the electrode is made of a transparent oxide film.

12. The flat panel display device of claim 1, wherein the electrode is made of indium tin oxide.

13. The flat panel display device of claim 1, wherein the sealing member is made of glass frit.

14. The flat panel display device of claim 1, wherein the sealing member comprises a support frame having a predetermined height, a first frit layer disposed between the first substrate and the support frame, and a second frit layer disposed between the second substrate and the support frame.
